(19) United States
(12) Patent Application Publication
(10) Pub. No.: US 2026/0155492 A1
(43) Pub. Date: Jun. 4, 2026

(54) BATTERY PACK

(71) Applicant: MURATA MANUFACTURING CO., LTD., Kyoto (JP)

(72) Inventor: Yuta NIKAIDO, Kyoto (JP)

(21) Appl. No.: 19/423,404

(22) Filed: Dec. 17, 2025

Related U.S. Application Data
(63) Continuation of application No. PCT/JP2024/021811, filed on Jun. 17, 2024.

(30) Foreign Application Priority Data
Aug. 14, 2023 (JP) 2023-132005

(51) Int. Cl. H01M 10/659; H01M 50/213; H01M 50/291

(52) U.S. Cl. CPC H01M 10/659; H01M 50/213; H01M 50/291; H01M 2200/10

(57) ABSTRACT

A battery pack is provided and includes a battery and a heat-absorbing member. The heat-absorbing member includes a heat-absorbing agent and a container housing the heat-absorbing agent. The heat-absorbing member is disposed at a position adjacent to the battery. The container has a cutout.

### CROSS REFERENCE TO RELATED APPLICATIONS

The present application is a continuation of International Application No. PCT/JP2024/021811, filed on Jun. 17, 2024, which claims priority to Japanese Patent Application No. 2023-132005, filed on Aug. 14, 2023, the entire contents of which are incorporated herein by reference.

### BACKGROUND

The present technology relates to a battery pack.

Electronic equipment have been widely used, which has promoted development of a battery as a power source to be applied to the electronic equipment. In this case, in order to handle multiple batteries easily and safely, a battery pack including the multiple batteries has been proposed.

A technique related to a configuration of the battery pack has been considered in various ways. For example, a heat-absorbing member is disclosed that is brought into contact with a battery in a battery unit, and the battery that has generated abnormal heat is cooled by the heat-absorbing member.

### SUMMARY

The present technology relates to a battery pack.

Regarding a battery pack, there is a concern that it can be difficult to sufficiently cool a battery that has generated abnormal heat by a heat-absorbing member, depending on an arrangement or a structure of the heat-absorbing member. It is desirable to provide a battery pack that makes it possible to sufficiently cool a battery that has generated abnormal heat by a heat-absorbing member.

A battery pack according to an embodiment of the present technology includes a battery and a heat-absorbing member. The heat-absorbing member includes a heat-absorbing agent and a container housing the heat-absorbing agent. The heat-absorbing member is disposed at a position adjacent to the battery. The container has a cutout.

A battery pack according to an embodiment of the present technology includes a battery and a heat-absorbing member. The heat-absorbing member includes a heat-absorbing agent and a container housing the heat-absorbing agent. The heat-absorbing member is disposed at a position adjacent to the battery. The container includes a housing part and a flange part. The housing part houses the heat-absorbing agent. The flange part is provided around the housing part and has a peelable part configured to cause a housing space of the housing part to communicate with an outside by being peeled off upon heating. The peelable part has a narrow region where a width of the peelable part is locally narrower than a width of the flange part.

According to the battery pack of an embodiment of the present technology, the cutout is provided in the container of the heat-absorbing member disposed at a position adjacent to the battery. This allows the heat-absorbing agent leaked to an outside through the cutout to come into contact with and cool the battery that has generated abnormal heat. Providing the cutout at a desired location of the container thus makes it possible to effectively cool the battery that has generated abnormal heat. Accordingly, it is possible to sufficiently cool the battery that has generated abnormal heat by the heat-absorbing member.

According to the battery pack of an embodiment of the present technology, the flange part of the container of the heat-absorbing member disposed at a position adjacent to the battery is provided with the peelable part configured to cause the housing space of the housing part to communicate with the outside by being peeled off upon heating. The peelable part is provided with the narrow region where the width of the peelable part is locally narrower than the width of the flange part. This makes it possible for the peelable part to be peeled off by heat of the battery that has generated abnormal heat, allowing the heat-absorbing agent leaked from the container to come into contact with and cool the battery that has generated abnormal heat. Providing the peelable part at a desired location of the container thus makes it possible to effectively cool the battery that has generated abnormal heat. Accordingly, it is possible to sufficiently cool the battery that has generated abnormal heat by the heat-absorbing member.

Note that effects of the present technology are not necessarily limited to those described herein and may include any of a series of effects including described below in relation to the present technology.

### BRIEF DESCRIPTION OF THE FIGURES

FIG. 1 is a diagram illustrating a perspective configuration example of a battery pack according to an embodiment of the present technology.

FIG. 2 is a diagram illustrating a perspective configuration example of a battery module to be housed in the battery pack of FIG. 1.

FIG. 3 is a diagram illustrating an exploded perspective configuration example of the battery pack of FIG. 1.

FIG. 4 is a diagram illustrating a sectional configuration example of the battery module of FIG. 2.

FIG. 5 is a diagram illustrating a perspective configuration example of a heat-absorbing module of FIG. 4.

FIG. 6 includes Part (A) which is a diagram illustrating a perspective configuration example of a heat-absorbing member of FIG. 5. Parts (B) and (C) of FIG. 6 are diagrams illustrating a sectional configuration example of the heat-absorbing member of part (A) of FIG. 6 taken along line A-A.

FIG. 7 includes Parts (A) and (B) that are diagrams illustrating, in an enlarged manner, a partial sectional configuration example of part (B) of FIG. 6.

FIG. 8 is a diagram illustrating, in an enlarged manner, a partial perspective configuration example of the heat-absorbing member of part (A) of FIG. 6.

FIG. 9 is a diagram illustrating, in an enlarged manner, a section of a part of the battery module of FIG. 2.

FIG. 10 is a diagram illustrating an example of a manufacturing process of the heat-absorbing member of part (B) of FIG. 6.

FIG. 11 includes Part (A) that is a diagram illustrating one modification example of a sectional configuration of the heat-absorbing member of part (A) of FIG. 7. Part (B) of FIG. 11 is a diagram illustrating one modification example of a sectional configuration of the heat-absorbing member of part (B) of FIG. 7.

FIG. 12 includes Part (A) which is a diagram illustrating one modification example of a perspective configuration of the heat-absorbing member of part (A) of FIG. 6. Parts (B) and (C) of FIG. 12 are diagrams illustrating a sectional configuration example of the heat-absorbing member of part (A) of FIG. 12 taken along line A-A.

FIG. 13 includes Parts (A) and (B) which are diagrams illustrating, in an enlarged manner, a partial sectional configuration example of part (B) of FIG. 12.

FIG. 14 is a diagram illustrating, in an enlarged manner, a partial perspective configuration example of the heat-absorbing member of part (A) of FIG. 12.

FIG. 15 is a diagram illustrating an example of a manufacturing process of the heat-absorbing member of part (A) of FIG. 12.

FIG. 16 is a diagram illustrating one modification example of a perspective configuration of the heat-absorbing member of FIG. 8.

FIG. 17 is a diagram illustrating one modification example of a perspective configuration of the heat-absorbing member of FIG. 8.

FIG. 18 is a diagram illustrating one modification example of a perspective configuration of the heat-absorbing member of FIG. 8.

FIG. 19 is a diagram illustrating an example of a manufacturing process of the heat-absorbing member of FIG. 18.

FIG. 20 is a diagram illustrating one modification example of a perspective configuration of the heat-absorbing member of FIG. 8.

FIG. 21 is a diagram illustrating an example of a manufacturing process of the heat-absorbing member of FIG. 20.

### DETAILED DESCRIPTION

The present technology is described below in further detail including with reference to the drawings according to an embodiment.

A description is given first of a battery pack according to an embodiment of the present technology.

The battery pack to be described here is a power source including multiple batteries and is to be applied to a variety of uses such as electronic equipment. Details of the uses of the battery pack will be described later. The battery is not particularly limited in kind and may be a primary battery or a secondary battery. The secondary battery is not particularly limited in kind, but is specifically, for example, a lithium-ion secondary battery in which a battery capacity is obtainable through insertion and extraction of lithium ions. The number of batteries is not particularly limited, and may be set as desired. Hereinafter, a case in which the battery is a secondary battery (a lithium-ion secondary battery) will be described. In other words, the battery pack described below is a power source including multiple secondary batteries.

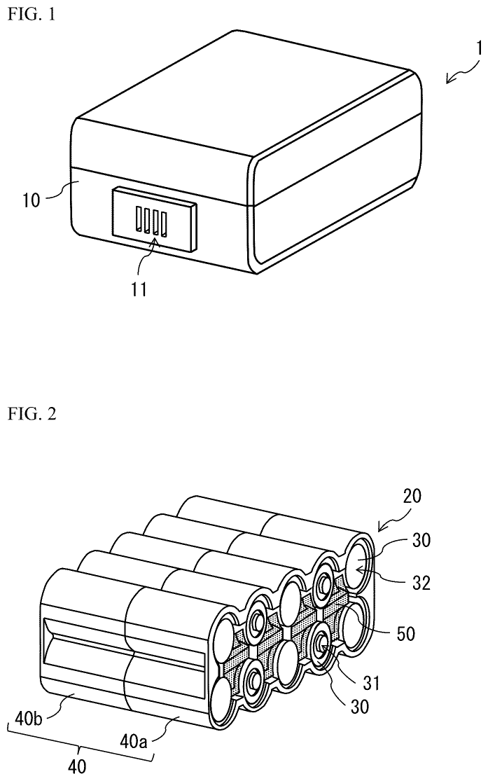

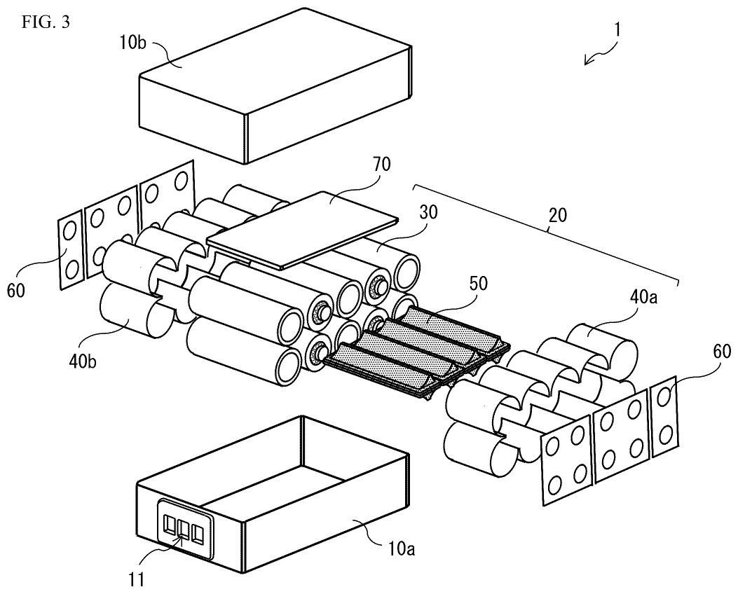

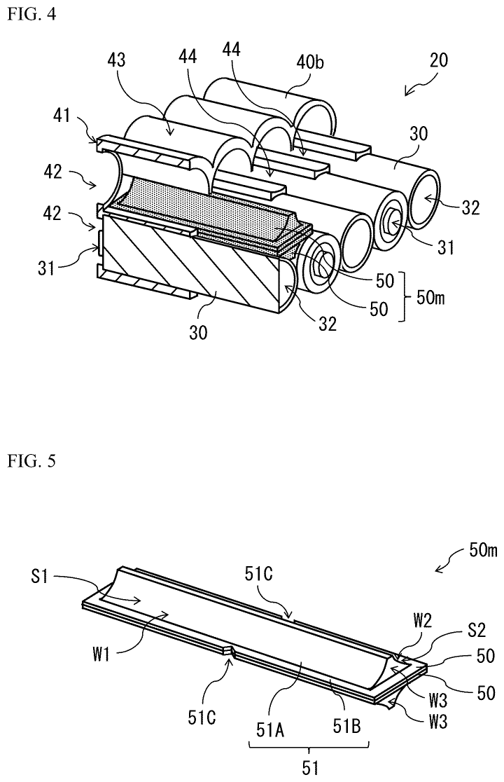

FIG. 1 illustrates a perspective configuration example of a battery pack 1 according to an embodiment of the present technology. FIG. 2 illustrates a perspective configuration example of a battery module 20 to be housed in the battery pack 1. FIG. 3 illustrates an exploded perspective configuration example of the battery pack 1. FIG. 4 illustrates a sectional configuration example of the battery module 20.

The battery pack 1 includes an outer casing 10, the battery module 20, multiple metal tabs 60, and a control board 70, for example, as illustrated in FIGS. 1 to 3. The control board 70 is, for example, coupled to positive and negative electrode terminals of the battery module 20 via the multiple metal tabs 60 and includes a circuit that performs operations such as measuring a voltage of the batteries or the battery module 20, detecting a remaining capacity of the battery module 20, and detecting presence or absence of an overcurrent by measuring a current outputted from the battery module 20.

The outer casing 10 houses the battery module 20, the multiple metal tabs 60, and the control board 70. The outer casing 10 includes a lower casing 10a and an upper casing 10b, for example, as illustrated in FIG. 3. The lower casing 10a and the upper casing 10b are stacked on each other to form a housing space that houses the battery module 20, the multiple metal tabs 60, and the control board 70. The outer casing 10 (for example, the lower casing 10a) is provided with an external terminal 11 coupled to the control board 70. The battery module 20 is coupled to the external terminal 11 via the control board 70.

The battery pack 1 has a discharge mode in which electric power outputted from the battery module 20 is supplied to a load via the external terminal 11. The battery pack 1 may further have a charge mode in which electric power supplied via the external terminal 11 from a power source coupled to the external terminal 11 is accumulated in the battery module 20. When a battery 30 to be described later is a secondary battery, the control board 70 switches between the discharge mode and the charge mode in accordance with a kind of a coupled object coupled to the external terminal 11. When the battery 30 to be described later is a primary battery, the control board 70 executes only the discharge mode.

The battery module 20 includes multiple batteries 30, for example, as illustrated in FIGS. 2 and 3. The multiple batteries 30 are electrically coupled to each other via the multiple metal tabs 60. Each of the batteries 30 includes a positive electrode 31 and a negative electrode 32, for example, as illustrated in FIG. 2. Each of the batteries 30 includes, for example, a cylindrical battery in which the positive electrode 31 and the negative electrode 32 extend in opposite directions to each other. In the battery module 20, for example, some of the multiple batteries 30 are coupled in series with each other by the metal tabs 60. Further, when the batteries 30 coupled in series with each other are referred to as a series unit, multiple series units are coupled in parallel with each other by the metal tabs 60. Note that how the multiple batteries 30 are coupled to each other is not limited to the above.

Each of the metal tabs 60 includes, for example, a metal lead plate. Each of the batteries 30 is a primary battery or a secondary battery. When each of the batteries 30 is a secondary battery, the secondary battery is not particularly limited in kind, but is specifically, for example, a lithium-ion secondary battery in which a battery capacity is obtainable through insertion and extraction of lithium ions. Hereinafter, a case in which each of the batteries 30 is a secondary battery (a lithium-ion secondary battery) will be described. In other words, the battery pack 1 described below is a power source including multiple secondary batteries.

The battery module 20 further includes a battery holder 40 that supports the multiple batteries 30, and multiple heat-absorbing members 50 disposed between the multiple batteries 30, for example, as illustrated in FIGS. 2 and 3. The battery holder 40 has a structure that supports the multiple batteries 30 in layered form with a predetermined gap therebetween. The heat-absorbing members 50 will be described in detail later.

FIG. 4 illustrates a sectional configuration example of the battery module 20. The battery holder 40 includes a pair of holders 40a and 40b, for example, as illustrated in FIGS. 3 and 4. The holders 40a and 40b have a common structure.

Each of the holders 40a and 40b includes a side plate part 41, for example, as illustrated in FIG. 4. The side plate part 41 of the holder 40a and the side plate part 41 of the holder 40b are disposed to be opposed to each other with the multiple batteries 30 interposed therebetween in an extending direction of each of the batteries 30 (a direction in which the positive electrode 31 and the negative electrode 32 are opposed to each other). In the holders 40a and 40b, the side plate parts 41 have openings 42 at locations opposed to the positive electrodes 31 and the negative electrodes 32 of the batteries 30. Thus, the positive electrode 31 or the negative electrode 32 is exposed in each of the openings 42.

Each of the holders 40a and 40b further includes a support part 43 that supports the multiple batteries 30 in layered form with a predetermined gap therebetween, for example, as illustrated in FIG. 4. The side plate part 41 is coupled to each of two opposite end parts of the support parts 43 as a whole. Here, it is assumed that the support parts 43 support four or more cylindrical batteries 30 in layered form with a predetermined gap therebetween. In this case, the support parts 43 have openings 44 at locations surrounded by four cylindrical batteries 30 adjacent to each other, for example, as illustrated in FIG. 4. A heat-absorbing module 50m including two heat-absorbing members 50 stacked on each other is disposed at a position surrounded by four cylindrical batteries 30 adjacent to each other, for example, as illustrated in FIGS. 4 and 5. The heat-absorbing module 50m is in contact with outer peripheral surfaces of the four cylindrical batteries 30 in each opening 44.

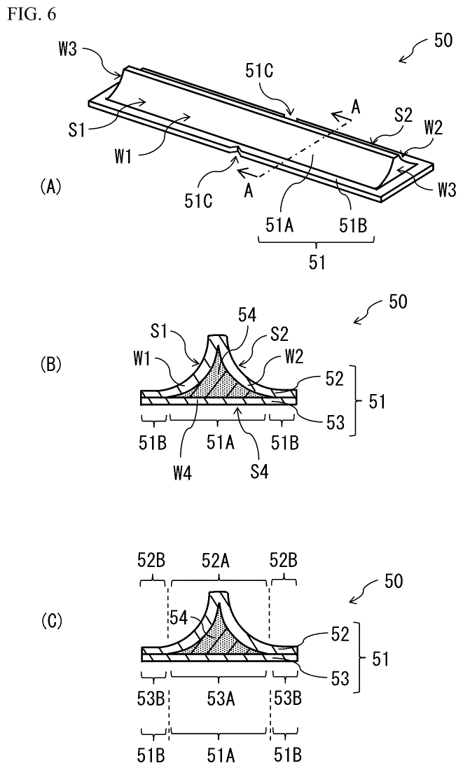

The heat-absorbing module 50m extends in a direction parallel to the extending direction of each of the batteries 30 (the direction in which the positive electrode 31 and the negative electrode 32 are opposed to each other). Each of the heat-absorbing members 50 included in the heat-absorbing module 50m also extends in a direction parallel to the extending direction of each of the batteries 30 (the direction in which the positive electrode 31 and the negative electrode 32 are opposed to each other). In the heat-absorbing module 50m, one of the heat-absorbing members 50 is in contact with the outer peripheral surfaces of two batteries 30 disposed in an upper layer among the four cylindrical batteries 30 adjacent to each other, and the other heat-absorbing member 50 is in contact with the outer peripheral surfaces of two batteries 30 disposed in a lower layer among the four cylindrical batteries 30 adjacent to each other. In the heat-absorbing module 50m, respective flat surfaces of the two heat-absorbing members 50 (flat surfaces S4 to be described later (see part (B) of FIG. 6)) are stacked on each other. Each opening 44 is in contact with the side plate part 41 of the holder 40a and the side plate part 41 of the holder 40b. Each heat-absorbing member 50 is in contact with the side plate part 41 of the holder 40a and the side plate part 41 of the holder 40b in the opening 44.

Part (A) of FIG. 6 illustrates a perspective configuration example of the heat-absorbing member 50. Parts (B) and (C) of FIG. 6 illustrate a sectional configuration example of the heat-absorbing member 50 taken along line A-A. Part (B) of FIG. 6 mainly presents reference numerals for a shape of a container 51, and part (C) of FIG. 6 mainly presents reference numerals for a housing part and a flange part of the container 51.

The heat-absorbing member 50 has a shape corresponding to a shape of the gap between the multiple batteries 30 supported by the battery holder 40 (the support parts 43). The heat-absorbing member 50 has an elongated columnar shape. Here, it is assumed that four or more cylindrical batteries 30 are supported by the battery holder 40 (the support parts 43) in layered form with a predetermined gap therebetween. In this case, the heat-absorbing module 50m including two heat-absorbing members 50 stacked on each other is in contact with surfaces (the outer peripheral surfaces) of four cylindrical batteries 30 adjacent to each other, and has, for example, a shape corresponding to the shape of the gap between the four cylindrical batteries 30 adjacent to each other. A section, of the heat-absorbing module 50m, in a direction perpendicular to the extending direction of the heat-absorbing module 50m has a substantially rhombic shape. In this case, a section, of the heat-absorbing member 50, in a direction perpendicular to the extending direction of the heat-absorbing member 50 has a substantially triangular shape, for example, as illustrated in part (B) of FIG. 6.

Here, two cylindrical batteries 30 adjacent to each other are referred to as a first battery 30 and a second battery 30. In this case, the heat-absorbing member 50 has an arc wall W1 (an arc surface S1) extending along the outer peripheral surface of the first battery 30, and an arc wall W2 (an arc surface S2) extending along the outer peripheral surface of the second battery 30. The arc wall W2 is disposed at a position adjacent to the arc wall W1. The two arc walls W1 and W2 (or the two arc surfaces S1 and S2) each have a concave shape conforming to the outer peripheral surface of the battery 30. The heat-absorbing member 50 further has, at each of two opposite end parts in a longitudinal direction of the heat-absorbing member 50, an end wall W3 constituting a part of the end part in the longitudinal direction of the heat-absorbing member 50. The heat-absorbing member 50 further has a flat wall W4 (the flat surface S4) at a location opposed to the arc walls W1 and W2 with a heat-absorbing agent 54 to be described later interposed therebetween. The end wall W3 is disposed at a position adjacent to both of the arc walls W1 and W2.

The heat-absorbing member 50 includes the heat-absorbing agent 54 and the container 51 covering the heat-absorbing agent 54, for example, as illustrated in parts (B) and (C) of FIG. 6.

The container 51 covers the heat-absorbing agent 54. The container 51 is formed by, for example: thermal-fusion-bonding two stacked bodies 52 and 53 to each other into a container, leaving one side open; filling the container with the heat-absorbing agent 54; and thereafter thermal-fusion-bonding the remaining one side used as a filling port. Accordingly, the container 51 houses the heat-absorbing agent 54. The stacked body 52 corresponds to a specific example of a “first container component” according to an embodiment of the present technology. The stacked body 53 corresponds to a specific example of a “second container component” according to an embodiment of the present technology.

The container 51 includes a housing part 51A housing the heat-absorbing agent 54 and a flange part 51B provided around the housing part 51A, for example, as illustrated in parts (A) and (C) of FIG. 6. The housing part 51A corresponds to a substantially triangular-prism-shaped part, of the container 51, constituted by the arc walls W1 and W2, the end walls W3, and a part of the flat wall W4. The flange part 51B corresponds to a plate-shaped part, of the container 51, provided to surround the housing part 51A, as viewed from a direction normal to the flat wall W4.

The stacked body 52 includes a first housing part 52A constituting a part of the housing part 51A and a first flange part 52B constituting a part of the flange part 51B. The first housing part 52A corresponds to a part constituted by the arc walls W1 and W2 and the end walls W3. The first housing part 52A and the first flange part 52B are provided as a single-piece part, and the first flange part 52B of the stacked body 52 is coupled to a second flange part 53B to be described later. The stacked body 53 includes a second housing part 53A constituting a part of the housing part 51A and the second flange part 53B constituting a part of the flange part 51B. The second housing part 53A corresponds to a part constituted by a part of the flat wall W4. The second housing part 53A and the second flange part 53B are provided as a single-piece part, and the second flange part 53B of the stacked body 53 is coupled to the first flange part 52B.

The first housing part 52A corresponds to a specific example of a “first housing part” according to an embodiment of the present technology. The first flange part 52B corresponds to a specific example of a “first flange part” according to an embodiment of the present technology. The second housing part 53A corresponds to a specific example of a “second housing part” according to an embodiment of the present technology. The second flange part 53B corresponds to a specific example of a “second flange part” according to an embodiment of the present technology.

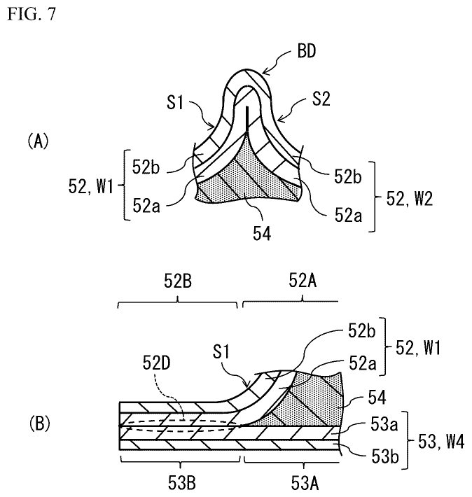

Parts (A) and (B) of FIG. 7 illustrate, in an enlarged manner, a partial sectional configuration example of part (B) of FIG. 6. Part (A) of FIG. 7 is an enlarged view of a boundary between the arc wall W1 and the arc wall W2. Part (B) of FIG. 7 is an enlarged view of a part where the stacked body 52 and the stacked body 53 are coupled to each other. The stacked body 52, the first housing part 52A, and the first flange part 52B include a resin layer 52a, for example, as illustrated in parts (A) and (B) of FIG. 7. The stacked body 53, the second housing part 53A, and the second flange part 53B include a resin layer 53a, for example, as illustrated in parts (A) and (B) of FIG. 7. The resin layers 52a and 53a include, for example, a resin material such as polyethylene, polystyrene, polypropylene, or polycarbonate.

The stacked body 52, the first housing part 52A, and the first flange part 52B may include, for example, stacked films. The stacked body 52, the first housing part 52A, and the first flange part 52B include the resin layer 52a and a metal layer 52b in this order from a side closer to the heat-absorbing agent 54, for example, as illustrated in parts (A) and (B) of FIG. 7. In this case, the stacked body 52, the first housing part 52A, and the first flange part 52B include the resin layer 52a. The metal layer 52b includes, for example, a metal foil such as an aluminum foil.

The stacked body 53, the second housing part 53A, and the second flange part 53B may include, for example, stacked films. The stacked body 53, the second housing part 53A, and the second flange part 53B include the resin layer 53a and a metal layer 53b in this order from the side closer to the heat-absorbing agent 54, for example, as illustrated in parts (A) and (B) of FIG. 7. In this case, the stacked body 53, the second housing part 53A, and the second flange part 53B include the resin layer 53a. The metal layer 53b includes, for example, a metal foil such as an aluminum foil.

The heat-absorbing agent 54 includes, for example, a liquid including water, or a hydrogel. When using the hydrogel as the heat-absorbing agent 161, it is preferable to use a synthetic polymer gel. Examples of a material of the synthetic polymer gel include sodium polyacrylate (PNaAA), polyvinyl alcohol (PVA), polyhydroxyethyl methacrylate (PHE-MA), and silicone hydrogel.

The stacked body 52 has a shape that is bent at an acute angle at a boundary BD between the arc wall W1 and the arc wall W2, for example, as illustrated in part (A) of FIG. 7. In the flange part 51B, the stacked body 52 and the stacked body 53 are welded to each other, and a part of the resin layer 52a of the stacked body 52 and a part of the resin layer 53a of the stacked body 53 are welded to each other, for example, as illustrated in part (B) of FIG. 7. A part where the part of the resin layer 52a of the stacked body 52 and the part of the resin layer 53a of the stacked body 53 are welded to each other is a welded part 52D in part (B) of FIG. 7. In the flange part 51B, the first flange part 52B and the second flange part 53B are welded to each other, and a part of the resin layer 52a of the first flange part 52B and a part of the resin layer 53a of the second flange part 53B are welded to each other, for example, as illustrated in part (B) of FIG. 7. A part where the part of the resin layer 52a of the first flange part 52B and the part of the resin layer 53a of the second flange part 53B are welded to each other is the welded part 52D in part (B) of FIG. 7.

In the flange part 51B, the welded part 52D extends all the way through the flange part 51B in an in-plane direction, for example, as illustrated in part (B) of FIG. 7. Thus, in the flange part 51B, when the welded part 52D is heated by, for example, heat of the battery 30 that has generated abnormal heat, the welded part 52D is peeled off by the heating, allowing a housing space of the housing part 51A to communicate with an outside. As a result, the heat-absorbing agent 54 leaks through an end part of the flange part 51B to the outside (for example, a peripheral surface of the battery 30 that has generated abnormal heat). The welded part 52D therefore serves as a peelable part that is configured to cause the housing space of the housing part 51A to communicate with the outside by being peeled off upon heating.

Note that the welded part 52D may be unexposed on an end face of the flange part 51B. In this case, the resin layer 52a of the stacked body 52 and the resin layer 53a of the stacked body 53 may only be physically in contact with each other between the end face of the flange part 51B and the welded part 52D, and may be peelable without being heated. For example, the resin layer 52a of the stacked body 52 and the resin layer 53a of the stacked body 53 may be held in contact with each other by an adhesive between the end face of the flange part 51B and the welded part 52D. Further, the welded part 52D may be unexposed to the housing space of the housing part 51A. In this case, the resin layer 52a of the stacked body 52 and the resin layer 53a of the stacked body 53 may only be physically in contact with each other between the welded part 52D and the housing space of the housing part 51A, and may be peelable without being heated. For example, the resin layer 52a of the stacked body 52 and the resin layer 53a of the stacked body 53 may be held in contact with each other by an adhesive between the welded part 52D and the housing space of the housing part 51A. Even in this case, in the flange part 51B, when the welded part 52D is heated by, for example, heat of the battery 30 that has generated abnormal heat, the welded part 52D is peeled off by the heating, allowing the housing space of the housing part 51A to communicate with the outside. As a result, the heat-absorbing agent 54 leaks through the end part of the flange part 51B to the outside (for example, the peripheral surface of the battery 30 that has generated abnormal heat). The welded part 52D therefore serves as the peelable part that is configured to cause the housing space of the housing part 51A to communicate with the outside by being peeled off upon heating.

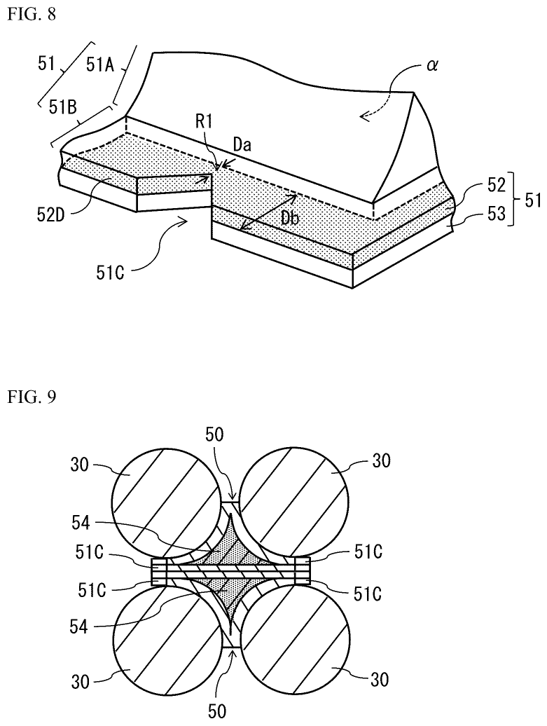

FIG. 8 illustrates, in an enlarged manner, a perspective configuration example of a part of the heat-absorbing member 50 of part (A) of FIG. 6. FIG. 9 illustrates, in an enlarged manner, a sectional configuration example of a part of the battery module 20 of FIG. 2. FIG. 9 illustrates a sectional configuration example at a position including a cutout 51C to be described later. In the present embodiment, the container 51 is provided with one or more cutouts 51C, for example, as illustrated in part (A) of FIG. 6 and FIG. 8. Each of the cutouts 51C is provided on the flange part 51B. An adhered part (the welded part 52D) of the first flange part 52B and the second flange part 53B has an area (a narrow region R1) where a width Da of the adhered part (the welded part 52D) is locally narrower than a width Db of the flange part 51B. The width Db of the flange part 51B refers to the width of a plate-shaped part of the stacked bodies 52 and 53, and more specifically, refers to the width of the plate-shaped part on a side of the stacked bodies 52 and 53 where the narrow region R1 is present. Note that FIG. 8 illustrates a state in which a maximum value of the width Da of the welded part 52D is equal to the width Db of the flange part 51B.

Each of the cutouts 51C is provided to extend through the stacked bodies 52 and 53. Each of the cutouts 51C is provided to extend through the adhered part (the welded part 52D) of the resin layer 52a of the first flange part 52B and the resin layer 53a of the second flange part 53B. Each of the cutouts 51C is provided adjacent to the welded part 52D. Each of the cutouts 51C may have an acute corner protruding toward a housing space α of the housing part 51A as viewed from a direction allowing a full view of the flange part 51B, for example, as illustrated in FIG. 8. In this case, the narrow region R1 may be provided adjacent to the acute corner.

Each of the cutouts 51C is disposed at a position adjacent to two batteries 30 adjacent to each other, for example, as illustrated in FIG. 9. Each of the cutouts 51C is disposed in a middle region of the heat-absorbing member 50 in the longitudinal direction of the heat-absorbing member 50, for example, as illustrated in part (A) of FIG. 6. Here, the term “middle region” refers to, for example, a region in the flange part 51B that is away from each of the end walls W3 by a length greater than or equal to a height of the end wall W3.

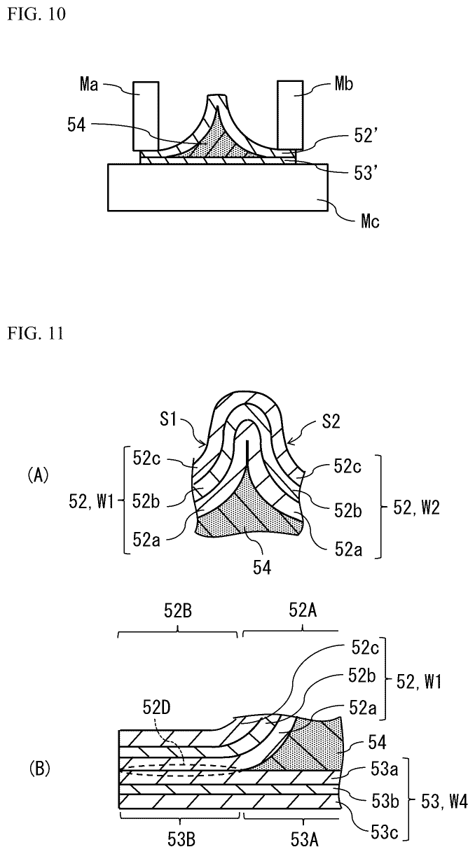

A description is given next of an example of a method of manufacturing the heat-absorbing member 50. FIG. 10 illustrates an example of a process of manufacturing the heat-absorbing member 50. First, a stacked body 52′ shaped into a mountain shape by drawing and a flat stacked body 53′ are stacked on each other. Thereafter, mold pieces Ma and Mb are pressed against a flange part of the stacked body 52′, and the stacked body 53′ is supported by a flat-plate-shaped mold piece Mc. In this state, the mold pieces Ma and Mb are heated to a predetermined temperature (FIG. 10). As a result, the heat of each of the mold pieces Ma and Mb propagates to the resin layers 52a and 53a in the stacked bodies 52′ and 53′, allowing parts of the resin layers 52a and 53a to be welded to form the welded part 52D. In this case, one side is left non-fusion-bonded while the other sides are fusion-bonded. As a result, the stacked bodies 52′ and 53′ are formed into a container shape. Thereafter, the mold pieces Ma, Mb, and Mc are removed from the stacked bodies 52′ and 53′. Thereafter, the container, in which the stacked bodies 52′ and 53′ are thermal-fusion-bonded to each other with one side left open, is filled with the heat-absorbing agent 54. After the filling, the remaining one side used as a filling port is thermal-fusion-bonded. Thereafter, the one or more cutouts 51C are formed at predetermined locations of the stacked bodies 52′ and 53′. The heat-absorbing member 50 is manufactured in this manner.

Next, effects of the battery pack 1 will be described.

Electronic equipment have been widely used, which has promoted development of a battery as a power source to be applied to the electronic equipment. In this case, in order to handle multiple batteries easily and safely, a battery pack including the multiple batteries has been proposed.

A technique related to a configuration of the battery pack has been considered in various ways. Specifically, a heat-absorbing member is in contact with a side surface of a battery unit, and the heat-absorbing member includes an outer film containing a gel fluid as a heat-absorbing agent inside (for example, see PTL 1).

Regarding a battery pack, there is a concern that it can be difficult to sufficiently cool a battery that has generated abnormal heat by a heat-absorbing member, depending on an arrangement or a structure of the heat-absorbing member.

In contrast, in the present embodiment, the cutouts 51C are provided in the container 51 of the heat-absorbing member 50 disposed at a position adjacent to the batteries 30. This makes it possible for the heat-absorbing agent 54 leaked to the outside through the cutouts 51C to come into contact with and cool the battery 30 that has generated abnormal heat. Providing the cutouts 51C at desired locations of the container 51 thus makes it possible to effectively cool the battery 30 that has generated abnormal heat. Accordingly, it is possible to sufficiently cool the battery 30 that has generated abnormal heat by the heat-absorbing member 50.

In the present embodiment, the width Da of the adhered part (the welded part 52D) of the first flange part 52B and the second flange part 53B is locally narrower than the width Db of the flange part 51B. The width Da of the welded part 52D is locally narrowed by each of the cutouts 51C. Thus, in the flange part 51B, when the welded part 52D is heated by heat of the battery 30 that has generated abnormal heat, the narrow region R1, of the welded part 52D, generated by each of the cutouts 51C is peeled off first by the heating, allowing the housing space of the housing part 51A to communicate with the outside. As a result, the heat-absorbing agent 54 leaks through the end part of the flange part 51B to the outside (for example, the peripheral surface of the battery 30 that has generated abnormal heat). This makes it possible for the leaked heat-absorbing agent 54 to come into contact with and cool the battery 30 that has generated abnormal heat. Providing the cutouts 51C at desired locations of the container 51 thus makes it possible to effectively cool the battery 30 that has generated abnormal heat. As described above, it is possible to sufficiently cool the battery 30 that has generated abnormal heat by the heat-absorbing member 50.

In the present embodiment, the first housing part 52A and the second housing part 53A each have a shape that makes an outer appearance of the housing part 51A have a substantially triangular prism shape. Thus, when the heat-absorbing module 50m including the two heat-absorbing members 50 stacked on each other is disposed at a position surrounded by the four cylindrical batteries 30 adjacent to each other, it is possible to bring the heat-absorbing module 50m into contact with the outer peripheral surfaces of the four cylindrical batteries 30. As a result, it is possible for the leaked heat-absorbing agent 54 to come into contact with and cool the battery 30 that has generated abnormal heat. Providing the cutouts 51C at desired locations of the container 51 thus makes it possible to effectively cool the battery 30 that has generated abnormal heat. As described above, it is possible to sufficiently cool the battery 30 that has generated abnormal heat by the heat-absorbing member 50.

In the present embodiment, an area, of the stacked body 52, corresponding to the first flange part 52B and an area, of the stacked body 53, corresponding to the second flange part 53B are adhered to each other. Each of the cutouts 51C is provided to extend through the stacked bodies 52 and 53. Thus, when the welded part 52D is heated by heat of the battery 30 that has generated abnormal heat, the narrow region R1, of the welded part 52D, generated by each of the cutouts 51C is peeled off first by the heating, allowing the housing space of the housing part 51A to communicate with the outside. As a result, the heat-absorbing agent 54 leaks through the end part of the flange part 51B to the outside (for example, the peripheral surface of the battery 30 that has generated abnormal heat). This makes it possible for the leaked heat-absorbing agent 54 to come into contact with and cool the battery 30 that has generated abnormal heat. Providing the cutouts 51C at desired locations of the container 51 thus makes it possible to effectively cool the battery 30 that has generated abnormal heat. As described above, it is possible to sufficiently cool the battery 30 that has generated abnormal heat by the heat-absorbing member 50.

In the present embodiment, the resin layer 52a of the first flange part 52B and the resin layer 53a of the second flange part 53B are welded to each other, and each of the cutouts 51C is provided to extend through the welded part 52D of the resin layer 52a of the first flange part 52B and the resin layer 53a of the second flange part 53B. Thus, when the welded part 52D is heated by heat of the battery 30 that has generated abnormal heat, the narrow region R1, of the welded part 52D, generated by each of the cutouts 51C is peeled off first by the heating, allowing the housing space of the housing part 51A to communicate with the outside. As a result, the heat-absorbing agent 54 leaks through the end part of the flange part 51B to the outside (for example, the peripheral surface of the battery 30 that has generated abnormal heat). This makes it possible for the leaked heat-absorbing agent 54 to come into contact with and cool the battery 30 that has generated abnormal heat. Providing the cutouts 51C at desired locations of the container 51 thus makes it possible to effectively cool the battery 30 that has generated abnormal heat. As described above, it is possible to sufficiently cool the battery 30 that has generated abnormal heat by the heat-absorbing member 50.

In the present embodiment, each of the cutouts 51C is disposed at a position adjacent to the two batteries 30 adjacent to each other. Each of the cutouts 51C is disposed in the middle region of the heat-absorbing member 50 in the longitudinal direction of the heat-absorbing member 50. Thus, when the welded part 52D is heated by heat of the battery 30 that has generated abnormal heat, the narrow region R1, of the welded part 52D, generated by each of the cutouts 51C is peeled off first by the heating, allowing the housing space of the housing part 51A to communicate with the outside. As a result, the heat-absorbing agent 54 leaks through the end part of the flange part 51B to the outside (for example, the peripheral surface of the battery 30 that has generated abnormal heat). This makes it possible for the leaked heat-absorbing agent 54 to come into contact with and cool the battery 30 that has generated abnormal heat. Providing the cutouts 51C at desired locations of the container 51 thus makes it possible to effectively cool the battery 30 that has generated abnormal heat. As described above, it is possible to sufficiently cool the battery 30 that has generated abnormal heat by the heat-absorbing member 50.

Next, a description will be given of modification examples of the battery pack 1 according toan embodiment.

Part (A) of FIG. 11 illustrates a modification example of a sectional configuration of the heat-absorbing member of part (A) of FIG. 7. Part (B) of FIG. 11 illustrates a modification example of a sectional configuration of the heat-absorbing member of part (B) of FIG. 7. In the above-described embodiment, the stacked body 52 may have a configuration in which the metal layer 52b is sandwiched between the resin layer 52a and a resin layer 52c, for example, as illustrated in parts (A) and (B) of FIG. 11. In the above-described embodiment, the stacked body 53 may have a configuration in which the metal layer 53b is sandwiched between the resin layer 53a and a resin layer 53c, for example, as illustrated in part (B) of FIG. 11. The resin layers 52c and 53c include, for example, a resin material such as polyethylene, polystyrene, polypropylene, or polycarbonate. In this case, the cutouts 51C extend through the resin layers 52c and 53c. In this manner, the metal layer 52b is covered with the resin layer 52c, and the metal layer 53b is covered with the resin layer 53c. This makes it possible to more reliably prevent the metal layers 52b and 53b from being short-circuited to an electric conductor in the battery module 20.

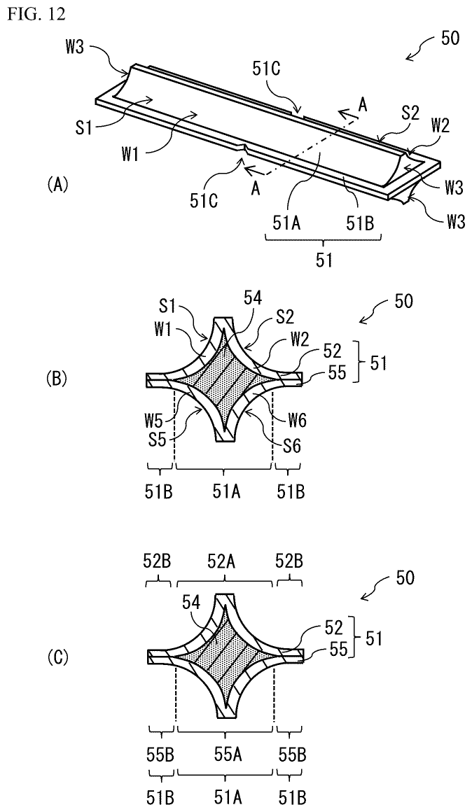

Part (A) of FIG. 12 illustrates a modification example of a perspective configuration of the heat-absorbing member of part (A) of FIG. 6. Parts (B) and (C) of FIG. 12 illustrate a sectional configuration example of the heat-absorbing member of part (A) of FIG. 12 taken along line A-A. Part (B) of FIG. 12 mainly presents reference numerals for the shape of the container 51, and part (C) of FIG. 12 mainly presents reference numerals for the housing part and the flange part of the container 51.

In the present modification example, the heat-absorbing member 50 has a shape corresponding to a shape of the gap between the multiple batteries 30 supported by the battery holder 40 (the support parts 43). Similarly to each of the batteries 30, the heat-absorbing member 50 has an elongated columnar shape. Here, it is assumed that four or more cylindrical batteries 30 are supported by the battery holder 40 (the support parts 43) in layered form with a predetermined gap therebetween. In this case, the heat-absorbing member 50 is in contact with surfaces (the outer peripheral surfaces) of four cylindrical batteries 30 adjacent to each other, and has, for example, a shape corresponding to the shape of the gap between the four cylindrical batteries 30 adjacent to each other. A section, of the heat-absorbing member 50, in a direction perpendicular to the extending direction of the heat-absorbing member 50 has a substantially rhombic shape. In this case, a section, of the heat-absorbing member 50, in a direction perpendicular to the extending direction of the heat-absorbing member 50 has a substantially rhombic shape, for example, as illustrated in part (B) of FIG. 12.

Here, the two cylindrical batteries 30 adjacent to each other are referred to as the first battery 30 and the second battery 30. In this case, the heat-absorbing member 50 has the arc wall W1 (the arc surface S1) extending along the outer peripheral surface of the first battery 30, and the arc wall W2 (the arc surface S2) extending along the outer peripheral surface of the second battery 30. The arc wall W2 is disposed at a position adjacent to the arc wall W1. The two arc walls W1 and W2 (or the two arc surfaces S1 and S2) each have a concave shape conforming to the outer peripheral surface of the battery 30.

Furthermore, two cylindrical batteries 30 adjacent to each other are referred to as a third battery 30 and a fourth battery 30. In this case, the heat-absorbing member 50 has an arc wall W5 (an arc surface S5) extending along the outer peripheral surface of the third battery 30, and an arc wall W6 (an arc surface S6) extending along the outer peripheral surface of the fourth battery 30. The arc wall W6 is disposed at a position adjacent to the arc wall W5. The two arc walls W5 and W6 (or the two arc surfaces S5 and S6) each have a concave shape conforming to the outer peripheral surface of the battery 30.

The heat-absorbing member 50 further has, at each of two opposite end parts in the longitudinal direction of the heat-absorbing member 50, the end wall W3 constituting a part of the end part in the longitudinal direction of the heat-absorbing member 50. The end wall W3 is disposed at a position adjacent to both of the arc walls W1 and W2. Additionally, the end wall W3 is disposed at a position adjacent to both of the arc walls W5 and W6.

The heat-absorbing member 50 includes the heat-absorbing agent 54 and the container 51 covering the heat-absorbing agent 54, for example, as illustrated in parts (B) and (C) of FIG. 12.

The container 51 covers the heat-absorbing agent 54. The container 51 is formed by, for example, heating and shaping the heat-absorbing agent 54, the stacked body 52, and a stacked body 55 in a state in which the heat-absorbing agent 54 is covered with the two stacked bodies 52 and 55. Accordingly, the container 51 houses the heat-absorbing agent 54.

The container 51 includes the housing part 51A housing the heat-absorbing agent 54 and the flange part 51B provided around the housing part 51A, for example, as illustrated in parts (A) and (C) of FIG. 12. The housing part 51A corresponds to a substantially rhombic-prism-shaped part, of the container 51, constituted by the arc walls W1 and W2, the end walls W3, and the arc walls W5 and W6. The flange part 51B corresponds to a plate-shaped part, of the container 51, provided to surround the housing part 51A, as viewed from a direction allowing a full view of the arc walls W1 and W2.

The stacked body 52 includes the first housing part 52A constituting a part of the housing part 51A and the first flange part 52B constituting a part of the flange part 51B. The first housing part 52A corresponds to a part constituted by the arc walls W1 and W2 and the end walls W3. The first housing part 52A and the first flange part 52B are provided as a single-piece part, and the flange part 51B of the stacked body 52 is coupled to a second flange part 53B, which will be described later. The stacked body 55 includes a third housing part 55A constituting a part of the housing part 51A and the third flange part 55B constituting a part of the flange part 51B. The third housing part 55A corresponds to a part constituted by the arc walls W5 and W6 and the end walls W3. The third housing part 55A and the third flange part 55B are provided as a single-piece part, and the flange part 51B of the stacked body 55 is coupled to the first flange part 52B.

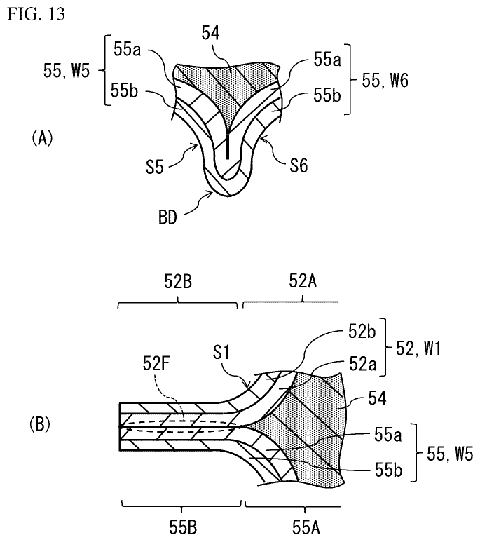

Parts (A) and (B) of FIG. 13 illustrate, in an enlarged manner, a partial sectional configuration example of part (B) of FIG. 12. Part (A) of FIG. 13 is an enlarged view of a boundary BD between the arc wall W5 and the arc wall W6. Part (B) of FIG. 13 is an enlarged view of a part where the stacked body 52 and the stacked body 55 are coupled to each other. The stacked body 55, the third housing part 55A, and the third flange part 55B include a resin layer 55a, for example, as illustrated in parts (A) and (B) of FIG. 13. The stacked body 55, the third housing part 55A, and the third flange part 55B include the resin layer 55a, for example, as illustrated in parts (A) and (B) of FIG. 13. The resin layer 55a includes, for example, a resin material such as polyethylene, polystyrene, polypropylene, or polycarbonate.

The stacked body 55, the third housing part 55A, and the third flange part 55B may include, for example, stacked films. The stacked body 55, the third housing part 55A, and the third flange part 55B include the resin layer 55a and a metal layer 55b in this order from the side closer to the heat-absorbing agent 54, for example, as illustrated in parts (A) and (B) of FIG. 13. In this case, the stacked body 55, the third housing part 55A, and the third flange part 55B include the resin layer 55a. The metal layer 55b includes, for example, a metal foil such as an aluminum foil.

The stacked body 55 has a shape that is bent at an acute angle at the boundary BD between the arc wall W5 and the arc wall W6, for example, as illustrated in part (A) of FIG. 13. At the boundary BD (bent part) between the arc wall W5 and the arc wall W6, a part of the resin layer 52a of the arc wall W5 and a part of the resin layer 52a of the arc wall W6 are welded to each other, for example, as illustrated in part (A) of FIG. 13. A part where the part of the resin layer 52a of the arc wall W5 and the part of the resin layer 52a of the arc wall W6 are welded to each other is the welded part 52D in part (A) of FIG. 13. In the flange part 51B, the stacked body 52 and the stacked body 55 are welded to each other, and a part of the resin layer 52a of the stacked body 52 and a part of the resin layer 55a of the stacked body 55 are welded to each other, for example, as illustrated in part (B) of FIG. 13. A part where the part of the resin layer 52a of the stacked body 52 and the part of the resin layer 53a of the stacked body 55 are welded to each other is the welded part 52D in part (B) of FIG. 13. In the flange part 51B, the first flange part 52B and the third flange part 55B are welded to each other, and a part of the resin layer 52a of the first flange part 52B and a part of the resin layer 55a of the third flange part 55B are welded to each other, for example, as illustrated in part (B) of FIG. 13. A part where the part of the resin layer 52a of the first flange part 52B and the part of the resin layer 55a of the third flange part 55B are welded to each other is the welded part 52D in part (B) of FIG. 13.

The welded part 52D is exposed on the end face of the flange part 51B, for example, as illustrated in part (B) of FIG. 13. Further, the welded part 52D is exposed to the housing space of the housing part 51A. In other words, in the flange part 51B, the welded part 52D extends all the way through the flange part 51B in the in-plane direction. Thus, in the flange part 51B, when the welded part 52D is heated by, for example, heat of the battery 30 that has generated abnormal heat, the welded part 52D is peeled off by the heating, allowing the housing space of the housing part 51A to communicate with the outside. As a result, the heat-absorbing agent 54 leaks through the end part of the flange part 51B to the outside (for example, the peripheral surface of the battery 30 that has generated abnormal heat). The welded part 52D therefore serves as the peelable part that is configured to cause the housing space of the housing part 51A to communicate with the outside by being peeled off upon heating.

Note that the welded part 52D may be unexposed on the end face of the flange part 51B. In this case, the resin layer 52a of the stacked body 52 and the resin layer 55a of the stacked body 55 may only be physically in contact with each other between the end face of the flange part 51B and the welded part 52D, and may be peelable without being heated. Further, the welded part 52D may be unexposed to the housing space of the housing part 51A. In this case, the resin layer 52a of the stacked body 52 and the resin layer 55a of the stacked body 55 may only be physically in contact with each other between the welded part 52D and the housing space of the housing part 51A, and may be peelable without being heated. Even in this case, in the flange part 51B, when the welded part 52D is heated by, for example, heat of the battery 30 that has generated abnormal heat, the welded part 52D is peeled off by the heating, allowing the housing space of the housing part 51A to communicate with the outside. As a result, the heat-absorbing agent 54 leaks through the end part of the flange part 51B to the outside (for example, the peripheral surface of the battery 30 that has generated abnormal heat). The welded part 52D therefore serves as the peelable part that is configured to cause the housing space of the housing part 51A to communicate with the outside by being peeled off upon heating.

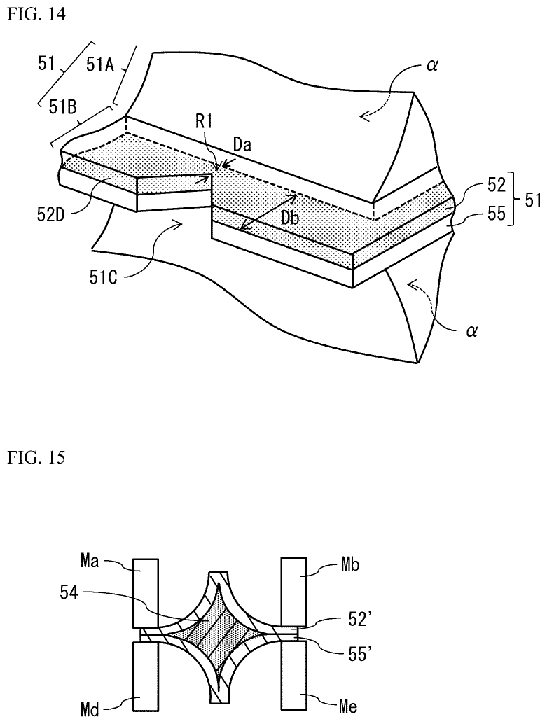

FIG. 14 illustrates, in an enlarged manner, a perspective configuration example of a part of the heat-absorbing member 50 of part (A) of FIG. 12. In the present modification example, the container 51 is provided with the one or more cutouts 51C, for example, as illustrated in part (A) of FIG. 12 and FIG. 14. Each of the cutouts 51C is provided on the flange part 51B. The welded part 52D has an area (the narrow region R1) where the width Da of the welded part 52D is locally narrower than the width Db of the flange part 51B. The width Db of the flange part 51B refers to the width of a plate-shaped part of the stacked bodies 52 and 55, and more specifically, refers to the width of the plate-shaped part on a side of the stacked bodies 52 and 55 where the narrow region R1 is present. Note that FIG. 14 illustrates a state in which a maximum value of the width Da of the welded part 52D is equal to the width Db of the flange part 51B.

Each of the cutouts 51C is provided to extend through the stacked bodies 52 and 55. Each of the cutouts 51C is provided to extend through the welded part 52D. Each of the cutouts 51C is provided adjacent to the welded part 52D. Each of the cutouts 51C may have an acute corner protruding toward the housing space α of the housing part 51A as viewed from a direction allowing a full view of the flange part 51B, for example, as illustrated in FIG. 14. In this case, the narrow region R1 may be provided adjacent to the acute corner.

Each of the cutouts 51C is disposed at a position adjacent to the two batteries 30 adjacent to each other. Each of the cutouts 51C is disposed in the middle region of the heat-absorbing member 50 in the longitudinal direction of the heat-absorbing member 50, for example, as illustrated in part (A) of FIG. 12. Here, the term “middle region” refers to, for example, a region in the flange part 51B that is away from each of the end walls W3 by a length greater than or equal to the height of the end wall W3.

A description is given next of an example of a method of manufacturing the heat-absorbing member 50 according to the present modification example. FIG. 15 illustrates an example of a process of manufacturing the heat-absorbing member 50. First, the stacked bodies 52′ and 55′ shaped into a mountain shape by drawing are stacked on each other. Thereafter, the mold pieces Ma and Mb are pressed against a flange part of the stacked body 52′, while mold pieces Md and Me are pressed against a flange part of the stacked body 55′. In this state, the mold pieces Ma, Mb, Md, and Me are heated to a predetermined temperature (FIG. 15). As a result, the heat of the mold pieces Ma, Mb, Md, and Me propagates to the resin layers 52a and 55a in the stacked bodies 52′ and 55′, allowing parts of the resin layers 52 a and 55 a to be welded to form the welded part 55D. In this case, one side is left non-fusion-bonded while the other sides are fusion-bonded. As a result, the stacked bodies 52′ and 55′ are formed into a container shape. Thereafter, the mold pieces Ma, Mb, Md, and Me are removed from the stacked bodies 52′ and 55′. Thereafter, the container, in which the stacked bodies 52′ and 55′ are thermal-fusion-bonded to each other with one side left open, is filled with the heat-absorbing agent 54. After the filling, the remaining one side used as a filling port is thermal-fusion-bonded. Thereafter, the one or more cutouts 51C are formed at predetermined locations of the stacked bodies 52′ and 55′. The heat-absorbing member 50 is manufactured in this manner.

In the present modification example, the cutouts 51C are provided in the container 51 of the heat-absorbing member 50 disposed at a position adjacent to the batteries 30. This makes it possible for the heat-absorbing agent 54 leaked to the outside through the cutouts 51C to come into contact with and cool the battery 30 that has generated abnormal heat. Providing the cutouts 51C at desired locations of the container 51 thus makes it possible to effectively cool the battery 30 that has generated abnormal heat. Accordingly, it is possible to sufficiently cool the battery 30 that has generated abnormal heat by the heat-absorbing member 50.

In the present modification example, the width Da of the adhered part (the welded part 52D) of the first flange part 52B and the third flange part 55B is locally narrower than the width Db of the flange part 51B. The width Da of the welded part 52D is locally narrowed by each of the cutouts 51C. Thus, in the flange part 51B, when the welded part 52D is heated by heat of the battery 30 that has generated abnormal heat, the narrow region R1, of the welded part 52D, generated by each of the cutouts 51C is peeled off first by the heating, allowing the housing space of the housing part 51A to communicate with the outside. As a result, the heat-absorbing agent 54 leaks through the end part of the flange part 51B to the outside (for example, the peripheral surface of the battery 30 that has generated abnormal heat). This makes it possible for the leaked heat-absorbing agent 54 to come into contact with and cool the battery 30 that has generated abnormal heat. Providing the cutouts 51C at desired locations of the container 51 thus makes it possible to effectively cool the battery 30 that has generated abnormal heat. As described above, it is possible to sufficiently cool the battery 30 that has generated abnormal heat by the heat-absorbing member 50.

In the present modification example, the first housing part 52A and the third housing part 55A each have a shape that makes an outer appearance of the housing part 51A have a substantially rhombic prism shape. Thus, when the heat-absorbing member 50 is disposed at a position surrounded by the four cylindrical batteries 30 adjacent to each other, it is possible to bring the heat-absorbing member 50 into contact with the outer peripheral surfaces of the four cylindrical batteries 30. As a result, it is possible for the leaked heat-absorbing agent 54 to come into contact with and cool the battery 30 that has generated abnormal heat. Providing the cutouts 51C at desired locations of the container 51 thus makes it possible to effectively cool the battery 30 that has generated abnormal heat. As described above, it is possible to sufficiently cool the battery 30 that has generated abnormal heat by the heat-absorbing member 50.

In the present modification example, an area, of the stacked body 52, corresponding to the first flange part 52B and an area, of the stacked body 55, corresponding to the third flange part 55B are adhered to each other. Each of the cutouts 51C is provided to extend through the stacked bodies 52 and 55. Thus, when the welded part 52D is heated by heat of the battery 30 that has generated abnormal heat, the narrow region R1, of the welded part 52D, generated by each of the cutouts 51C is peeled off first by the heating, allowing the housing space of the housing part 51A to communicate with the outside. As a result, the heat-absorbing agent 54 leaks through the end part of the flange part 51B to the outside (for example, the peripheral surface of the battery 30 that has generated abnormal heat). This makes it possible for the leaked heat-absorbing agent 54 to come into contact with and cool the battery 30 that has generated abnormal heat. Providing the cutouts 51C at desired locations of the container 51 thus makes it possible to effectively cool the battery 30 that has generated abnormal heat. As described above, it is possible to sufficiently cool the battery 30 that has generated abnormal heat by the heat-absorbing member 50.

In the present modification example, the resin layer 52a of the first flange part 52B and the resin layer 55a of the third flange part 55B are welded to each other, and each of the cutouts 51C is provided to extend through the welded part 52D of the resin layer 52a of the first flange part 52B and the resin layer 55a of the third flange part 55B. Thus, when the welded part 52D is heated by heat of the battery 30 that has generated abnormal heat, the narrow region R1, of the welded part 52D, generated by each of the cutouts 51C is peeled off first by the heating, allowing the housing space of the housing part 51A to communicate with the outside. As a result, the heat-absorbing agent 54 leaks through the end part of the flange part 51B to the outside (for example, the peripheral surface of the battery 30 that has generated abnormal heat). This makes it possible for the leaked heat-absorbing agent 54 to come into contact with and cool the battery 30 that has generated abnormal heat. Providing the cutouts 51C at desired locations of the container 51 thus makes it possible to effectively cool the battery 30 that has generated abnormal heat. As described above, it is possible to sufficiently cool the battery 30 that has generated abnormal heat by the heat-absorbing member 50.

In the present modification example, each of the cutouts 51C is disposed at a position adjacent to the two batteries 30 adjacent to each other. Each of the cutouts 51C is disposed in the middle region of the heat-absorbing member 50 in the longitudinal direction of the heat-absorbing member 50. Thus, when the welded part 52D is heated by heat of the battery 30 that has generated abnormal heat, the narrow region R1, of the welded part 52D, generated by each of the cutouts 51C is peeled off first by the heating, allowing the housing space of the housing part 51A to communicate with the outside. As a result, the heat-absorbing agent 54 leaks through the end part of the flange part 51B to the outside (for example, the peripheral surface of the battery 30 that has generated abnormal heat). This makes it possible for the leaked heat-absorbing agent 54 to come into contact with and cool the battery 30 that has generated abnormal heat. Providing the cutouts 51C at desired locations of the container 51 thus makes it possible to effectively cool the battery 30 that has generated abnormal heat. As described above, it is possible to sufficiently cool the battery 30 that has generated abnormal heat by the heat-absorbing member 50.

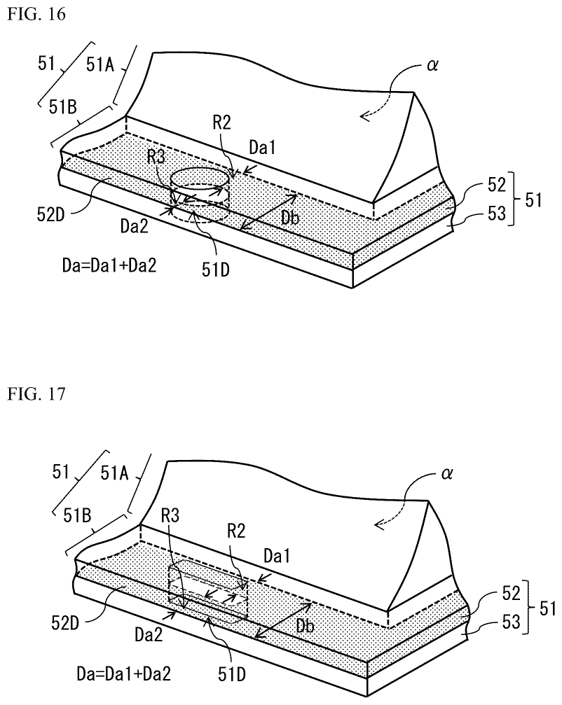

In the above-described embodiment and the modification examples thereof, a through hole 51D may be provided instead of each of the cutouts 51C, for example, as illustrated in FIG. 16. The through hole 51D is provided to extend through the flange part 51B, the welded part 52D, and the stacked bodies 52 and 53. The through hole 51D has a circular shape or an elliptical shape as viewed from a direction normal to the flange part 51B. In the welded part 52D, two narrow regions R2 and R3 are provided adjacent to the through hole 51D. Assuming that the narrow region R2 has a width Da1, and the narrow region R3 has a width Da2, the sum of the width Da1 and the width Da2 corresponds to the width Da in the above-described embodiment and the modification examples thereof. The width Da (=Da1+Da2) of an area, of the welded part 52D, where the narrow regions R2 and R3 are present is narrower than the width Db of the flange part 51B. Even in this case, it is possible to obtain effects similar to those obtained when the cutouts 51C are provided.

In the present modification example, the through hole 51D may have a rectangular shape as viewed from a direction normal to the flange part 51B, for example, as illustrated in FIG. 17. In this case, a longitudinal direction of the through hole 51D is, for example, parallel to an extending direction of an edge of the flange part 51B. The longitudinal direction of the through hole 51D may be a direction perpendicular to the extending direction of the edge of the flange part 51B. Even in this case, it is possible to obtain effects similar to those obtained when the cutouts 51C are provided.

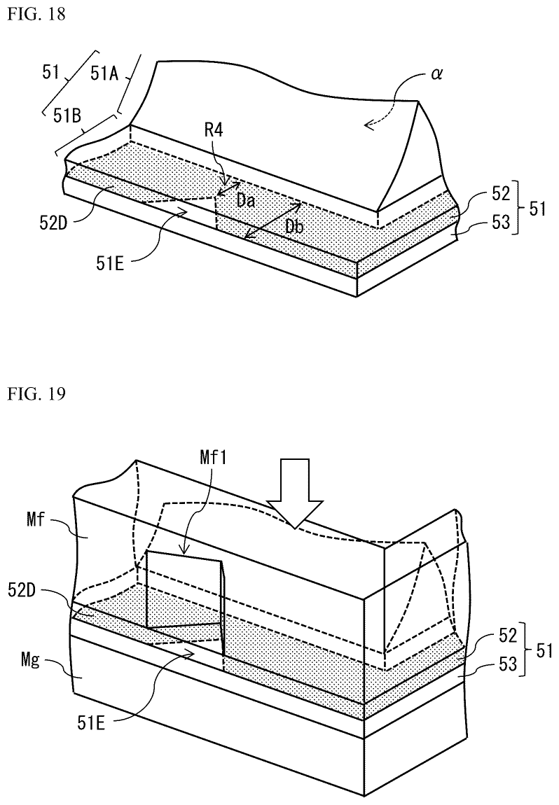

In the above-described embodiment and the modification examples thereof, a non-welded region 51E may be provided instead of each of the cutouts 51C, for example, as illustrated in FIG. 18. The non-welded region 51E is a region in which the stacked body 52 (the resin layer 52a) and the stacked body 53 (the resin layer 53a) are only in contact with each other, and in which the stacked body 52 (the resin layer 52a) and the stacked body 53 (the resin layer 53a) are configured to separate without being heated. The non-welded region 51E is exposed at the end part of the flange part 51B, for example. In the non-welded region 51E, a gap may be present, or the stacked body 52 (the resin layer 52a) and the stacked body 53 (the resin layer 53a) may be in close contact with each other and have no gap therebetween. For example, the non-welded region 51E may have an acute corner protruding toward the housing space α of the housing part 51A as viewed from a direction allowing a full view of the flange part 51B. In this case, a narrow region R4 may be provided adjacent to the acute corner. Even in this case, it is possible to obtain effects similar to those obtained when the cutouts 51C are provided.

A description is given next of a method of manufacturing the non-welded region 51E. The stacked bodies 52 and 53 are placed on a mold piece Mg having a flat surface, for example, as illustrated in FIG. 19. Thereafter, an end part of the stacked body 52 is pressed by a mold piece Mf having a cutout Mf1 corresponding to the shape of the non-welded region 51E. This forms the welded part 52D having the narrow region R4. As a result, an area where the welded part 52D is not formed becomes the non-welded region 51E.

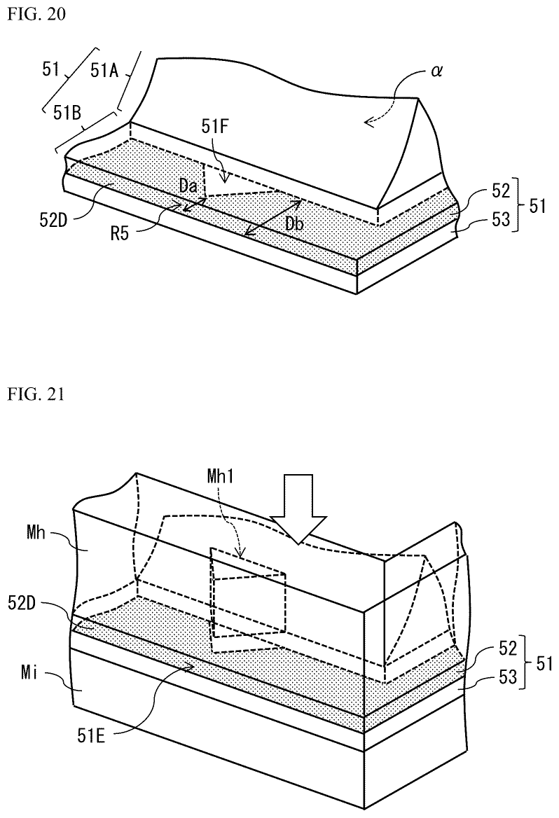

In the above-described embodiment and the modification examples thereof, a non-welded region 51F may be provided instead of each of the cutouts 51C, for example, as illustrated in FIG. 20. The non-welded region 51F is a region in which the stacked body 52 (the resin layer 52a) and the stacked body 53 (the resin layer 53a) are only in contact with each other, and in which the stacked body 52 (the resin layer 52a) and the stacked body 53 (the resin layer 53a) are configured to separate without being heated. The non-welded region 51F is provided, for example, in an area, of the flange part 51B, communicating with the housing space α of the housing part 51A. In the non-welded region 51F, a gap may be present, or the stacked body 52 (the resin layer 52a) and the stacked body 53 (the resin layer 53a) may be in close contact with each other and have no gap therebetween. When a gap is present in the non-welded region 51F, the gap may be filled with the heat-absorbing agent 54. The non-welded region 51F may have, for example, an acute corner protruding toward the end face of the flange part 51B as viewed from a direction allowing a full view of the flange part 51B. In this case, a narrow region R5 may be provided adjacent to the acute corner. Even in this case, it is possible to obtain effects similar to those obtained when the cutouts 51C are provided.

A description is given next of a method of manufacturing the non-welded region 51F. The stacked bodies 52 and 53 are placed on a mold piece Mi having a flat surface, for example, as illustrated in FIG. 21. Thereafter, the end part of the stacked body 52 is pressed by a mold piece Mh having a cutout Mh1 corresponding to the shape of the non-welded region 51F. This forms the welded part 52D having the narrow region R5. As a result, an area where the welded part 52D is not formed becomes the non-welded region 51F.

Although the present technology has been described above with reference tovarious embodiments including modification examples, the present technology is not limited thereto, and is modifiable in a variety of ways.

For example, although lithium is used as the electrode reactant of the secondary battery in the above-described embodiment and modification examples thereof, the electrode reactant is not particularly limited in kind. Specifically, the electrode reactant may be another element belonging to group 1 in the long period periodic table, such as sodium or potassium. The electrode reactant may be an element belonging to group 2 in the long period periodic table, such as magnesium or calcium. The electrode reactant may be another light metal such as aluminum.

The effects described herein are mere examples and are not limited thereto, and other effects may be obtained.

Note that the present technology may have any of the following configurations according to an embodiment.
<1>

A battery pack including:
a battery; and
a heat-absorbing member including a heat-absorbing agent and a container housing the heat-absorbing agent, in which
the heat-absorbing member is disposed at a position adjacent to the battery, and
the container has a cutout.
<2>

The battery pack according to <1>, in which
the container includes
   a housing part housing the heat-absorbing agent, and
   a flange part provided around the housing part, and
the cutout is provided in the flange part.
<3>

The battery pack according to <2>, in which
the container includes a first container component and a second container component,
the first container component includes a first housing part constituting a part of the housing part, and a first flange part constituting a part of the flange part,
the second container component includes a second housing part constituting a part of the housing part, and a second flange part constituting a part of the flange part,
the first housing part and the second housing part define a housing space of the housing part,
the first flange part and the second flange part are adhered to each other, and
an adhered part of the first flange part and the second flange part has an area where a width of the adhered part is locally narrowed by the cutout.
<4>

The battery pack according to <3>, in which the first housing part and the second housing part each have a shape that makes the housing part have a substantially triangular prism shape.
<5>

The battery pack according to <3>, in which the first housing part and the second housing part each have a shape that makes the housing part have a substantially rhombic prism shape.
<6>

The battery pack according to any one of <3> to <5>, in which
the first container component includes a first sheet material,
the first housing part and the first flange part are provided as a single-piece part including the first sheet material,
the second container component includes a second sheet material,
the second housing part and the second flange part are provided as a single-piece part including the second sheet material,
an area, of the first sheet material, corresponding to the first flange part and an area, of the second sheet material, corresponding to the second flange part are adhered to each other, and
the cutout extends through the first sheet material and the second sheet material.
<7>

The battery pack according to any one of <3> to <6>, in which the adhered part of the first flange part and the second flange part is configured to cause the housing space of the housing part to communicate with an outside by being peeled off upon heating.
<8>

The battery pack according to any one of <3> to <7>, in which
the first flange part and the second flange part each include a stacked body including a resin layer,
the resin layer of the first flange part and the resin layer of the second flange part are welded to each other, and
the cutout extends through a welded part of the resin layer of the first flange part and the resin layer of the second flange part.
<9>

The battery pack according to any one of <1> to <8>, in which
the battery includes a plurality of batteries, and
the cutout is disposed at a position adjacent to two of the batteries that are adjacent to each other.
<10>

The battery pack according to <9>, in which
the batteries and the heat-absorbing member each have a columnar shape, and
the cutout is disposed in a middle region of the heat-absorbing member in a longitudinal direction of the heat-absorbing member.
<11>

A battery pack including:
a battery; and
a heat-absorbing member including a heat-absorbing agent and a container housing the heat-absorbing agent, in which
the heat-absorbing member is disposed at a position adjacent to the battery,
the container includes
   a housing part housing the heat-absorbing agent, and
   a flange part provided around the housing part and having a peelable part configured to cause a housing space of the housing part to communicate with an outside by being peeled off upon heating, and
the peelable part has a narrow region where a width of the peelable part is locally narrower than a width of the flange part.
<12>

The battery pack according to <11>, in which the flange part has a cutout, a through hole, a separable part that is separable without being heated, or a separated part communicating with the housing space, at an area adjacent to the narrow region.
<13>

The battery pack according to <11> or <12>, in which
the container includes a first container component and a second container component,
the first container component includes a first housing part constituting a part of the housing part, and a first flange part constituting a part of the flange part,
the second container component includes a second housing part constituting a part of the housing part, and a second flange part constituting a part of the flange part,
the first housing part and the second housing part define the housing space of the housing part,
the first flange part and the second flange part are adhered to each other, and
an adhered part of the first flange part and the second flange part corresponds to the peelable part.
<14>

The battery pack according to <13>, in which the first housing part and the second housing part each have a shape that makes the housing part have a substantially triangular prism shape.
<15>

The battery pack according to <13>, in which the first housing part and the second housing part each have a shape that makes the housing part have a substantially rhombic prism shape.
<16>

The battery pack according to any one of <13> to <15>, in which
the first container component includes a first sheet material,
the first housing part and the first flange part are provided as a single-piece part including the first sheet material,
the second container component includes a second sheet material,
the second housing part and the second flange part are provided as a single-piece part including the second sheet material,
an area, of the first sheet material, corresponding to the first flange part and an area, of the second sheet material, corresponding to the second flange part are adhered to each other, and
the cutout, the through hole, the separable part, or the separated part is adjacent to an adhered part of the first sheet material and the second sheet material.
<17>

The battery pack according to any one of <13> to <16>, in which
the first flange part and the second flange part each include a stacked body including a resin layer,
the resin layer of the first flange part and the resin layer of the second flange part are welded to each other, and
the cutout, the through hole, the separable part, or the separated part is adjacent to a welded part of the resin layer of the first flange part and the resin layer of the second flange part.
<18>

The battery pack according to any one of <11> to <17>, in which
the battery includes a plurality of batteries, and
the cutout, the through hole, the separable part, or the separated part is disposed at a position adjacent to two of the batteries that are adjacent to each other.
<19>

The battery pack according to <18>, in which
the batteries and the heat-absorbing member each have a columnar shape, and
the cutout, the through hole, the separable part, or the separated part is disposed in a middle region of the heat-absorbing member in a longitudinal direction of the heat-absorbing member.

The effects described herein are mere examples, and effects of the present technology are therefore not limited to those described herein. Accordingly, the present technology may achieve any other effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a battery; and
a heat-absorbing member including a heat-absorbing agent and a container housing the heat-absorbing agent, wherein
the heat-absorbing member is disposed at a position adjacent to the battery, and
the container has a cutout.

2. The battery pack according to claim 1, wherein
the container includes
a housing part housing the heat-absorbing agent, and
a flange part provided around the housing part, and
the cutout is provided in the flange part.

3. The battery pack according to claim 2, wherein
the container includes a first container component and a second container component,
the first container component includes a first housing part constituting a part of the housing part, and a first flange part constituting a part of the flange part,
the second container component includes a second housing part constituting a part of the housing part, and a second flange part constituting a part of the flange part,
the first housing part and the second housing part define a housing space of the housing part,
the first flange part and the second flange part are adhered to each other, and
an adhered part of the first flange part and the second flange part has an area where a width of the adhered part is locally narrowed by the cutout.

4. The battery pack according to claim 3, wherein the first housing part and the second housing part each have a shape that makes the housing part have a substantially triangular prism shape.

5. The battery pack according to claim 3, wherein the first housing part and the second housing part each have a shape that makes the housing part have a substantially rhombic prism shape.

6. The battery pack according to claim 3, wherein
the first container component includes a first sheet material,
the first housing part and the first flange part are provided as a single-piece part including the first sheet material,
the second container component includes a second sheet material,
the second housing part and the second flange part are provided as a single-piece part including the second sheet material,
an area, of the first sheet material, corresponding to the first flange part and an area, of the second sheet material, corresponding to the second flange part are adhered to each other, and
the cutout extends through the first sheet material and the second sheet material.

7. The battery pack according to claim 3, wherein the adhered part of the first flange part and the second flange part is configured to cause the housing space of the housing part to communicate with an outside by being peeled off upon heating.

8. The battery pack according to claim 3, wherein
the first flange part and the second flange part each comprise a stacked body including a resin layer,
the resin layer of the first flange part and the resin layer of the second flange part are welded to each other, and
the cutout extends through a welded part of the resin layer of the first flange part and the resin layer of the second flange part.

9. The battery pack according to claim 1, wherein
the battery includes a plurality of batteries, and
the cutout is disposed at a position adjacent to two of the batteries that are adjacent to each other.

10. The battery pack according to claim 9, wherein
the batteries and the heat-absorbing member each have a columnar shape, and
the cutout is disposed in a middle region of the heat-absorbing member in a longitudinal direction of the heat-absorbing member.

11. A battery pack comprising:
a battery; and
a heat-absorbing member including a heat-absorbing agent and a container housing the heat-absorbing agent, wherein
the heat-absorbing member is disposed at a position adjacent to the battery,
the container includes
a housing part housing the heat-absorbing agent, and
a flange part provided around the housing part and having a peelable part configured to cause a housing space of the housing part to communicate with an outside by being peeled off upon heating, and
the peelable part has a narrow region where a width of the peelable part is locally narrower than a width of the flange part.

12. The battery pack according to claim 11, wherein the flange part has a cutout, a through hole, a separable part that is separable without being heated, or a separated part communicating with the housing space, at an area adjacent to the narrow region.

13. The battery pack according to claim 11, wherein
the container includes a first container component and a second container component,
the first container component includes a first housing part constituting a part of the housing part, and a first flange part constituting a part of the flange part,
the second container component includes a second housing part constituting a part of the housing part, and a second flange part constituting a part of the flange part,
the first housing part and the second housing part define the housing space of the housing part,
the first flange part and the second flange part are adhered to each other, and
an adhered part of the first flange part and the second flange part corresponds to the peelable part.

14. The battery pack according to claim 13, wherein the first housing part and the second housing part each have a shape that makes the housing part have a substantially triangular prism shape.

15. The battery pack according to claim 13, wherein the first housing part and the second housing part each have a shape that makes the housing part have a substantially rhombic prism shape.

16. The battery pack according to claim 13, wherein
the first container component includes a first sheet material,
the first housing part and the first flange part are provided as a single-piece part including the first sheet material,
the second container component includes a second sheet material,
the second housing part and the second flange part are provided as a single-piece part including the second sheet material,
an area, of the first sheet material, corresponding to the first flange part and an area, of the second sheet material, corresponding to the second flange part are adhered to each other, and
the cutout, the through hole, the separable part, or the separated part is adjacent to an adhered part of the first sheet material and the second sheet material.

17. The battery pack according to claim 13, wherein
the first flange part and the second flange part each comprise a stacked body including a resin layer,
the resin layer of the first flange part and the resin layer of the second flange part are welded to each other, and
the cutout, the through hole, the separable part, or the separated part is adjacent to a welded part of the resin layer of the first flange part and the resin layer of the second flange part.

18. The battery pack according to claim 11, wherein
the battery includes a plurality of batteries, and
the cutout, the through hole, the separable part, or the separated part is disposed at a position adjacent to two of the batteries that are adjacent to each other.

19. The battery pack according to claim 18, wherein
the batteries and the heat-absorbing member each have a columnar shape, and
the cutout, the through hole, the separable part, or the separated part is disposed in a middle region of the heat-absorbing member in a longitudinal direction of the heat-absorbing member.
